(19) United States
(12) Patent Application Publication
(10) Pub. No.: US 2023/0186414 A1
(43) Pub. Date: Jun. 15, 2023

(54) Methods and Systems for Consumer Harm Risk Assessment and Ranking Through Consumer Feedback Data

(71) Applicant: Rain Intelligence, LLC, Bakersfield, CA (US)

(72) Inventors: Mohammed Rashik, Bakersfield, CA (US); Mohamed Shakir, San Francisco, CA (US)

(21) Appl. No.: 17/550,999

(22) Filed: Dec. 14, 2021

(51) Int. Cl. G06Q 50/18; G06Q 30/00

(52) U.S. Cl. CPC G06Q 50/18; G06Q 30/018

(57) ABSTRACT

A class action lawsuit (CAL) computing device, including at least one processor in communication with at least one memory device is provided. The processor is configured to: (i) retrieve, from the at least one memory device, historical consumer feedback data, (ii) generate a model that identifies potential class actions or other types of aggregate litigation by classifying consumer feedback data based on their likelihood of widespread consumer harm, (iii) store the model in the at least one memory device, (iv) receive consumer feedback data from one or more data sources, and (v) provide at least one class action lawsuit recommendation based upon the generated model and current consumer feedback data.

### FIELD OF THE INVENTION

The present invention relates to artificial intelligence and machine learning computer modeling, and, more particularly to a computing device for providing a likelihood of a class action lawsuit based on proprietary data using artificial intelligence and machine learning models.

### BACKGROUND

Concerning class action lawsuit matters, liability arising from any type of legal harm and the data to assess such risks, are not in existence, more so, in a single source and may take years to collect, aggregate, process and assess. Indeed, class action lawsuits arising from such issues currently require a whole slew of resources wherein they are spending months, if not years, to “discover” or “surface” a potential class action. Furthermore, there is no structured, systematic, or standardized process, to discover potential consumer harm, assess potential claims, and then evaluate the merits and/or methods of redress for a potential claim.

As in many areas of law, class action lawsuit evaluation and procedure has lagged behind other industries in their use of modern technology. For example, the use of cryptocurrency to modernize banking or the use of blockchain technology for electronic document management. It would be beneficial to have an evaluation process that mitigated many of the technical problems of conventional class action lawsuit evaluation processes.

### BRIEF SUMMARY OF THE INVENTION

The present embodiments may relate to, inter alia, systems and methods for building and training a model to analyze collected data. The model may be built using historical data (e.g., historical class action lawsuit data, historical consumer data) to analyze collected data, such as proprietary or public data sets. Public data sets may include, but is not limited to consumer feedback data, news articles, press releases, blog posts, academic papers, and transaction data. In some embodiments, the model may use the historical data to relate historical class action lawsuit data to historical consumer data. Accordingly, collected data may be input into the model to predict the likelihood of a class action lawsuit based on collected data. In some embodiments, the predicted likelihood may indicate that a class action lawsuit may be viable.

In a first aspect, a computer-implemented method for providing the likelihood of a class action lawsuit is provided. The computer-implemented method may include: 1) retrieving, from the at least one memory device, historical consumer feedback data, 2) generating a model that identifies potential class actions or other types of aggregate litigation by classifying the historical consumer feedback data, 3) storing the model in the at least one memory device, 4) receiving consumer feedback data from one or more data sources, and 5) providing at least one class action lawsuit recommendation based upon the generated model and the consumer feedback data. The computer-implemented method may include additional, less, or alternate functionality including that discussed elsewhere herein.

In another aspect, a computer-implemented method for providing the likelihood of a class action lawsuit is provided. The computer-implemented method may include: 1) retrieving, from the at least one memory device, historical consumer feedback data, 2) generating a model that identifies potential class actions or other types of aggregate litigation by classifying the historical consumer feedback data, 3) receiving consumer feedback data from one or more data sources, and 4) providing a class action lawsuit recommendation based upon the generated model and the consumer feedback data in addition to one or more law firms determined to match the class action lawsuit recommendation. The CAL computing device may include additional, less, or alternate functionality including that discussed elsewhere herein.

In yet another aspect, a non-transitory computer-readable media having computer-executable instructions embodied thereon is provided. The instructions, when executed by a class action lawsuit (CAL) computing device including at least one processor in communication with a memory device may cause the at least one processor to: 1) retrieve, from the at least one memory device, historical consumer feedback data, 2) generate a model that identifies potential class actions or other types of aggregate litigation by classifying the historical consumer feedback data, 3) store the model in the at least one memory device, 4) receive consumer feedback data from one or more data sources, and 5) provide at least one class action lawsuit recommendation based upon the generated model and the consumer feedback data. The instructions may cause additional, less, or alternate functionality including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description refers to the accompanying figures in which:

FIG. 1 illustrates an exemplary class action lawsuit (CAL) modeling system in accordance with an exemplary embodiment of the present disclosure;

FIG. 2 illustrates an exemplary client computing device that may be used with the CAL modeling system illustrated in FIG. 1;

FIG. 3 illustrates an exemplary server computing device that may be used with the CAL modeling system illustrated in FIG. 1;

FIG. 4 is an exemplary computing and network environment for a class action lawsuit AI/ML system in accordance with at least one embodiment of the present disclosure;

FIG. 5 illustrates an exemplary diagram of a high-level computing architecture in accordance with at least one embodiment of the disclosure;

FIG. 6 illustrates an exemplary diagram of a high-level computing architecture of a data unification and consolidation engine in accordance with at least one embodiment of the disclosure;

FIG. 7 illustrates an exemplary segmentation engine module that may utilize algorithms to cluster consumer feedback based on the nature of issues faced by consumers semi-automatically in accordance with at least one embodiment of the disclosure;

FIG. 8 illustrates an exemplary classification engine module that may utilize algorithms to put groups of consumer harm into a class action category in accordance with at least one embodiment of the disclosure;

FIG. 9 illustrates an exemplary ranking engine that may rank class actions based on consumer harm and the probability of a class action and attorney’s fees in accordance with at least one embodiment of the disclosure;

FIG. 10 illustrates an exemplary flow diagram of a consumer harm risk assessment engine in accordance with at least one embodiment of the disclosure; and

FIGS. 11A-11I illustrate screenshots of an exemplary user interface in accordance with at least one embodiment of the disclosure.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for building and training a model to analyze collected data. The model may be built using historical data (e.g., historical class action lawsuit data, historical consumer data) to analyze collected data, such as proprietary or public data sets. Public data sets may include, but is not limited to, consumer feedback data, news articles, press releases, blog posts, academic papers, transaction data, or the like. In some embodiments, the model may use the historical data to relate historical class action lawsuit data to historical consumer data. Accordingly, collected data may be input into the model to predict the likelihood of a class action lawsuit based on collected data. In some embodiments, the predicted likelihood may indicate that a class action lawsuit may be viable. In one exemplary embodiment, the process may be performed by a class action lawsuit (CAL) computing device. In the exemplary embodiment, the CAL computing device may be in communication with a plurality of user computer devices and a plurality of provider computer devices.

### Exemplary System for Predicting a Class Action Lawsuit

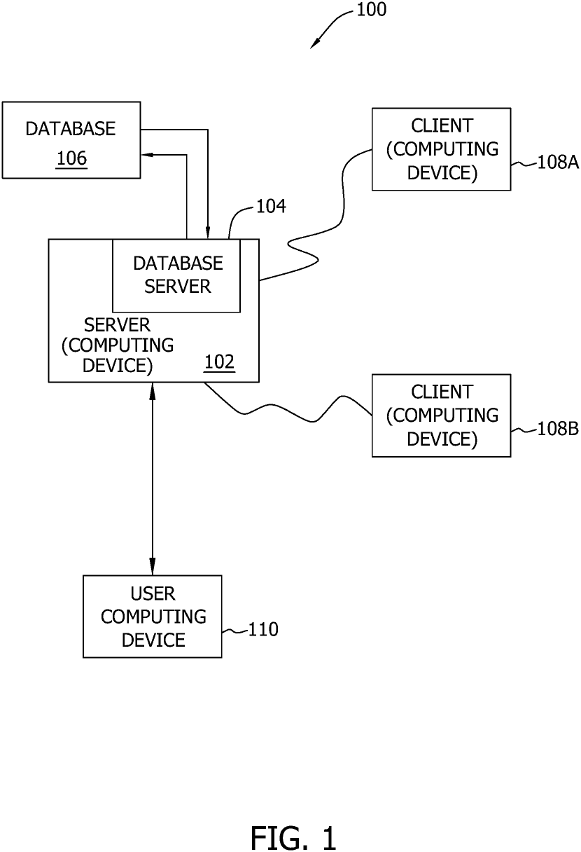

FIG. 1 depicts an exemplary class action lawsuit (CAL) computing system 100. CAL computing system 100 may include a CAL computing device 102 (also referred to herein as a CAL server or a CAL computer device). CAL computing device 102 may include a database server 104. Further, CAL computing device 102 may be in communication with, for example, a database 106, one or more client devices 108a and 108b, and a user computer device 110.

In the exemplary embodiments, client devices 108a and 108b may be computers that include a web browser or a software application, which enables the devices to access remote computer devices, such as CAL computing device 102, using the Internet or another type of network. More specifically, client devices 108a and 108b may be communicatively coupled to CAL computing device 102 through many interfaces including, but not limited to, a network, such as the Internet, a local area network (LAN), a wide area network (WAN), or an integrated services digital network (ISDN), a dial-up-connection, a digital subscriber line (DSL), a cellular phone connection, or even a cable modem. Client devices 108a and 108b may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

User device 110 may be a computer that includes a web browser or a software application, which enables user device 110 to access remote computer devices, such as CAL computing device 102, using the Internet or other network. In some embodiments, user device 110 may be associated with, or part of a computer network associated with, for example, public data sources, product review data sources, social media data sources, government data sources, academic studies data sources, toxic ingredient data sources, or the like. In other embodiments, user device 110 may be associated with a third party that may provide proprietary data, for example. In some embodiments, user device 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User device 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

Database server 104 may be communicatively coupled to database 106 that stores data. In one embodiment, database 106 may include user data associated with users (e.g., personal information, consumer feedback data), prediction data, third party data, etc. In the exemplary embodiment, database 106 may be located remotely from CAL computing device 102. In some embodiments, database 106 may be a decentralized database. In an exemplary embodiment, a user may access database 106 and/or CAL computing device 102 via one or more client devices 108a and 108b.

### Exemplary Client Computing Device

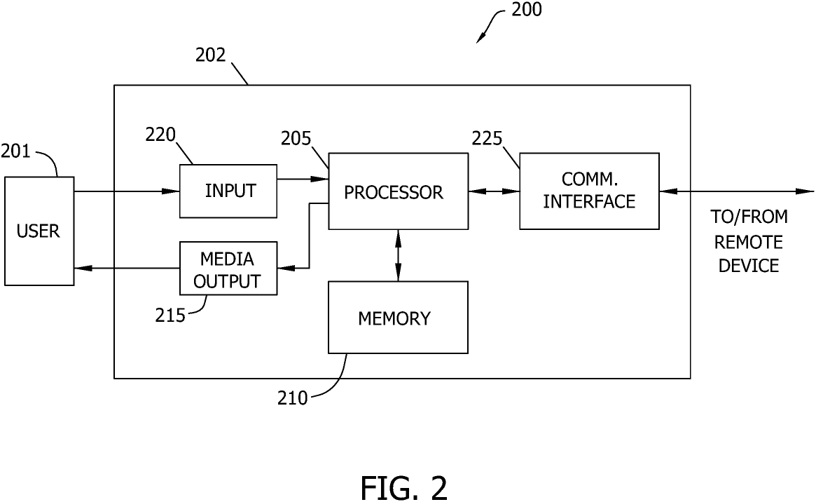

FIG. 2 illustrates a block diagram 200 of an exemplary client computing device 202 that may be used with CAL computing system 100 shown in FIG. 1. Client computing device 202 may be, for example, at least one of user device 110 or client devices 108a-108b (all shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In exemplary embodiments, processor 205 may include and/or be communicatively coupled to one or more modules for implementing the systems and methods described herein. For example, in one exemplary embodiment, a module may be provided for receiving data and building a model based upon the received data. Received data may include, but is not limited to, historical class action lawsuit data along with data corresponding to the historical class action lawsuit data, such as corresponding consumer feedback data, product data, or the like. A model may be built upon this received data, either by a different module or the same module that received the data. Processor 205 may include or be communicatively coupled to another module for generating a prediction of a class action lawsuit likelihood based upon collected data. Collected data may include, but is not limited to, consumer feedback data, news articles, press releases, blog posts, academic papers, and transaction data.

In one or more exemplary embodiments, computing device 202 may also include at least one media output component 215 for presenting information a user 201. Media output component 215 may be any component capable of conveying information to user 201. In some embodiments, media output component 215 may include an output adapter such as a video adapter and/or an audio adapter. An output adapter may be operatively coupled to processor 205 and operatively coupled to an output device such as a display device (e.g., a liquid crystal display (LCD), a light emitting diode (LED) display, an organic light emitting diode (OLED) display, a cathode ray tube (CRT) display, an “electronic ink” display, a projected display, etc.) or an audio output device (e.g., a speaker arrangement or headphones). Media output component 215 may be configured to, for example, display a status of the model and/or display a prompt for user 201 to input user data. In another embodiment, media output component 215 may be configured to, for example, display a result of a class action lawsuit prediction generated in response to receiving proprietary data and/or public datasets described herein and in view of the built model.

Client computing device 202 may also include an input device 220 for receiving input from a user 201. Input device 220 may include, for example, a keyboard, a pointing device, a mouse, a stylus, a touch sensitive panel (e.g., a touch pad or a touch screen), or an audio input device. A single component, such as a touch screen, may function as both an output device of media output component 215 and an input device of input device 220.

Client computing device 202 may also include a communication interface 225, which can be communicatively coupled to a remote device, such as Modeling computing device 102, shown in FIG. 1. Communication interface 225 may include, for example, a wired or wireless network adapter or a wireless data transceiver for use with a mobile phone network (e.g., Global System for Mobile communications (GSM), 3G, 4G, or Bluetooth) or other mobile data networks (e.g., Worldwide Interoperability for Microwave Access (WIMAX)). The systems and methods disclosed herein are not limited to any certain type of short-range or long-range networks.

Stored in memory area 210 may be, for example, computer readable instructions for providing a user interface to user 201 via media output component 215 and, optionally, receiving and processing input from input device 220. A user interface may include, among other possibilities, a web browser or a client application. Web browsers may enable users, such as user 201, to display and interact with media and other information typically embedded on a web page or a website.

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAN). The above memory types are exemplary only and are thus not limiting as to the types of memory usable for storage of a computer program.

### Exemplary Server Computing Device

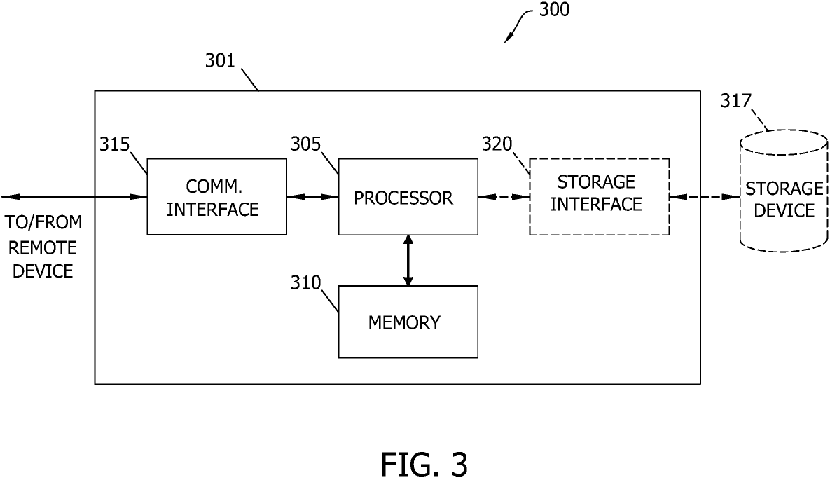

FIG. 3 depicts a block diagram 300 showing an exemplary server system 301 that may be used with the CAL computing system 100 illustrated in FIG. 1. Server system 301 may be, for example, CAL computing device 102 or database server 104 (shown in FIG. 1).

In exemplary embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 may be operatively coupled to a communication interface 315 such that server system 301 is capable of communicating with CAL computing device 102, client devices 108a and 108b, and user device 110 (all shown in FIG. 1), and/or another server system. For example, communication interface 315 may receive data from client devices 108a and 108b via the Internet.

Processor 305 may also be operatively coupled to a storage device 317, such as database 106 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer system.

### Exemplary Platform Architecture

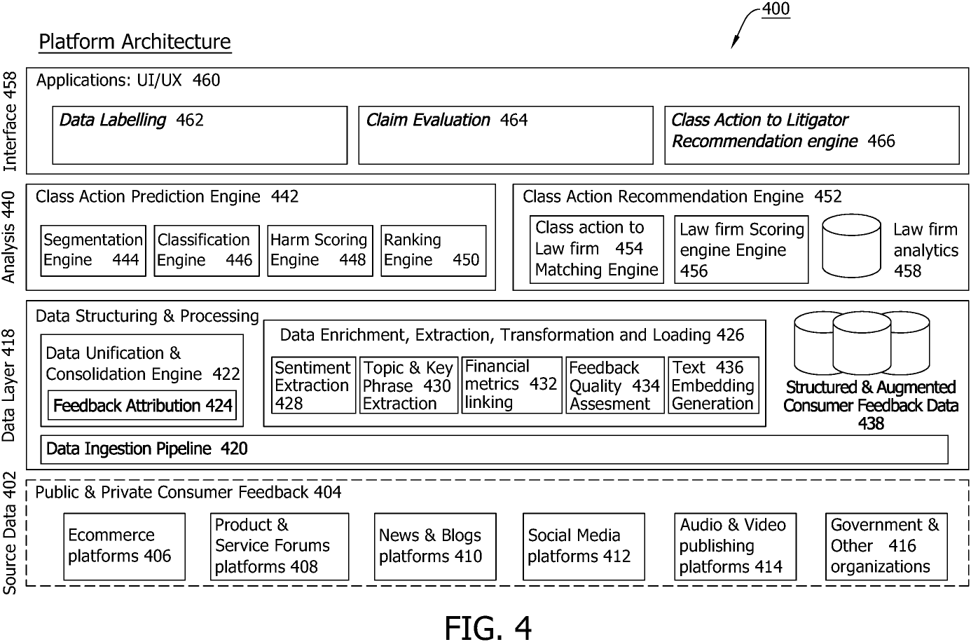

FIG. 4 is an example environment 400 which may represent how computing systems and networks may be organized, and interact with one another, to predict class action lawsuits based off of consumer feedback through an artificial intelligence (“AI”) and/or a machine learning (“ML”) system.

As shown in FIG. 4, in the Source Data 402 section, public and private consumer feedback 404 may be received from a plurality of data sources. The plurality of data sources may include, but is not limited to, Ecommerce platforms 406, Product & Service Forums platforms 408, News & Blogs platforms 410, Social Media platforms 412, Audio & Video publishing platforms 414, and Government & Other organizations 416. Additionally, data sources may include any source of any type which may contain information regarding consumer harm, be it automotive products or computer products, or some type of employment related dispute, for example. Such data sources may include public or confidential information. Additionally, or alternatively, data sources may be selected based on the type of class action lawsuit(s) to be, or possibly be, pursued. In some embodiments the Source Data section information may be the starting point of the analysis of whether such data may aggregate and form a potential class action lawsuit.

Further, with respect to FIG. 4, Platform Architecture 400 may include a Data Layer section 418. The Data Layer section 418 may include a Data Ingestion Pipeline 420 which receives data (e.g., consumer feedback) from Source Data 402. Once received, data may be fed to the Data Unification & Consolidation Engine 422. Engine 422 may unify the received data into a single format, thereby allowing consumer feedback data from multiple platforms (disparate sources) to be read and understood by one system, as a single format. Also, this data may then be exported out in a single readable format, which may be read by multiple disparate systems, thereby creating a standardized data structure.

These multiple platforms may be computer system operating systems (MacOS, Linux, Ubuntu, Microsoft Windows, ChromeOS), mobile phone operating systems (iOS, Android, or custom/proprietary), software applications (Microsoft Word, Google Docs, MongoDB, other proprietary and open source databases, etc.) or any other type of platform (HTTP/HTTPS based websites and APIs) which data may be in a different format from each other, and unstructured in reference to each other.

In some embodiments, the Data Unification & Consolidation Engine 422 may also utilize a Feedback Attribution module 424 to characterize/group consumer feedback data into groups of information which may relate to similarly situated class action lawsuits. Additionally, or alternatively, Data Layer 418 may include a Data Enrichment, Extraction, Transformation and Loading system 426. This system may use, for example, a Sentiment Extraction component 428, Topic & Key Phrase Extraction component 430, Financial Metrics Linking component 432, Feedback Quality Assessment component 434, and a Text Embedding Generation component 436. Output of Data Layer 418 system may include Structured & Augmented Consumer Feedback data 438, which may be stored on a database, such as database 106 (see FIG. 1). Data 428 may be persisted in the database for further processing.

Further, with respect to FIG. 4, Platform Architecture 400 may include an Analysis section 440. Analysis section 440 may include a Class Action Prediction Engine 442 and a Class Action Recommendation Engine 452. These engines themselves may function as AI/ML computational models which can rank and score consumer data, concerning whether a class action lawsuit may be viable. For example, thresholds may be barriers, if passed or crossed, which indicate that a class action lawsuit is viable.

The Class Action Prediction Engine 442 may consist of a Segmentation Engine 444, a Classification Engine 446, a Harm Scoring Engine 448, and a Ranking Engine 450. Segmentation Engine 444 may cluster consumer feedback based on the nature of the issue faced by consumers. In some embodiments, the Classification Engine 446 may utilize algorithms to place groups of consumers harm into a class action category. Additionally, or alternatively, Harm Scoring Engine 448 and Ranking Engine 450 may rank potential class actions by a score calculated using consumer harm, attorney fees, likelihood of success, or a combination thereof.

In some embodiments, the Class Action Recommendation Engine 452 may include a Class action to Law firm Matching Engine 454, a Law Firm Scoring Engine 456, and produce Law firm analytics 458. Law firm analytics may be stored on a database, such as database 106 (see FIG. 1). Engines 454, 456, and 458 may, for example, work in tandem to retrieve processed and analyzed consumer data, ascertain a type of class action lawsuit (e.g., product liability), and match potential law firms deemed to be fit to litigate a particular class action. One or more AI/ML models may utilize computed scores and rankings to determine if a threshold has been passed/crossed, where such passing/crossing of the threshold may mean that a class action lawsuit, based off of consumer data, is now viable.

Further, the Law firm Scoring Engine 456 may utilize data and outcome statistics in relation to law firms to provide rankings and scores of law firms in different class action litigation categories across different metric areas. Individual law firms may receive different weighted rankings which are associated with certain patterns of consumer harm to better match law firms with certain types of consumer harm. For example, Albert Law Firm, a fictional firm, may be ranked highly, or weighted heavily with respect to class action lawsuits which deal primary with computer battery issues in computers manufactured by Japanese companies only. Thus, computer battery issues in computers manufactured in the United States may not be considered a good match with Albert Law Firm for litigating a class action lawsuit.

Platform Architecture 400 of FIG. 4 also provides an Interface 458 section that may contain a plurality of UI/UX applications 460. Applications may include, but is not limited to, Data Labelling 462, Claim Evaluation 464, and a Class Action to Litigator Recommendation engine 466. Data Labelling 462 may be used to segment consumer data into groups and categories that identify the nature of the issue through a user interface. Claim Evaluation 464 may be used to manage the process of deciding whether an issue rising to the level of a class action that should be matched to a law firm. Claim Evaluation 464 may also be used to gather information helpful in describing qualities of the potential class action needed to utilize the Class Action Litigator Recommendation engine 466. Lastly, the Class Action to Litigator Recommendation engine 466 may be utilized through a user interface to show potential attorneys/law firms which may be a fit for the potential class action lawsuit identified, or show potential class actions that may be a fit for a particular attorney/law firm.

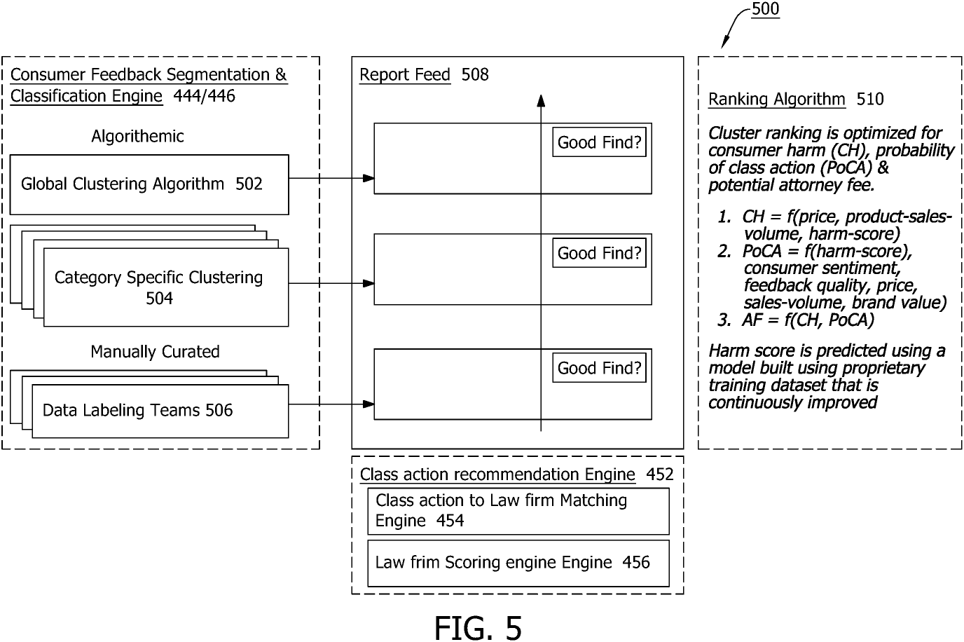

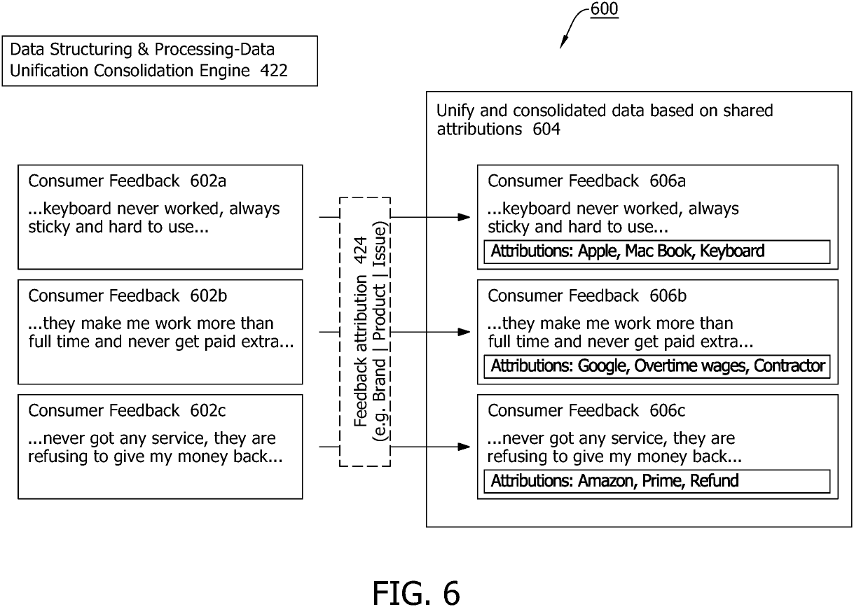

FIG. 5 depicts an exemplary diagram 500 of components described above with respect to FIG. 4. Consumer Feedback Segmentation 444 & Classification Engine 446 may include components which cluster consumer feedback into groups which identify the nature of the issue through a Global Clustering Algorithm 502 and specific category clustering through a Category Specific Clustering component 504. Also, a Data Labelling Teams component 506 may establish labels that may be manually applied to the consumer feedback data. With respect to AI/ML, new patterns, in this case of consumer harm feedback, may be applied to and ranked/weighted manually to associated output or results. In some embodiments, automation may occur when existing patterns are recognized which would then result in certain types of class action lawsuits being recognized and potentially certain individual law firms and/or attorneys which would be a match for those types of class action lawsuits.

As shown in FIG. 5, a Class Action Recommendation Engine 452 may utilize components of a Class action to Law firm Matching Engine 454 and a Law firm Scoring Engine 456. These two components may be utilized to match potential class action lawsuits derived from consumer feedback data to law firms which may be a fit, and also analyze data on law firms concerning prior litigation history, and other history, concerning class action lawsuits, to derive a score for a law firm.

As shown in FIG. 5, Report Feed 508 may provide an interface that shows the list of clusters, sorted by the Ranking Engine 450 of FIG. 4, to be labelled by a Data Labelling team 506. Using the Report Feed interface 508, the Data Labelling Team 506 may approve or modify the autogenerated segmentation and classification of the Structured and Augmented Consumer Feedback data 438. Once patterns of data are labelled, they will be automatically picked up by the AI/ML engine in the next data source retrieval.

FIG. 5 also depicts a Ranking Algorithm system 510. In some embodiments, Ranking Algorithm system 510 may utilize a ranking algorithm, in a form of cluster ranking, where the cluster ranking is optimized for consumer harm (CH), probability of class action (PoCA) & a potential attorney fee (AF). As described in this section, CH = f(price, product-sales-volume, harm-score), PoCA = f(harm-score, consumer sentiment, feedback quality, price, sales-volume, brand value), and AF = f(CH,, PoCA). In some embodiments, consumer harm score may be predicted using a model built using a proprietary training dataset that is continuously improved, and learned from, using one or more AI/ML engines.

FIG. 3 depicts diagram 600 providing an exemplary high level architecture of the Data Unification and Consolidation Engine 422 of FIG. 4. Moving from left to right, raw consumer feedback data 602a-602c may be processed through the Data Layer and then assigned “feedback attributions” 424 which give characteristics to the data in order for further processing (e.g. Brand | Product | Issue). As shown in the Unify and Consolidated Data Based in the Shared Attributions section 604, the raw consumer feedback data may be processed and assigned attributions characteristics of Brand = Apple; Product = Mac Book, and Issue = Keyboard. Processed consumer feedback may then become Consumer Feedback 606a-606c, as shown. As shown in one of the examples, the prior attribution characteristics may have been derived from consumer feedback stating “... keyboard never worked, always sticky and hard to use....”

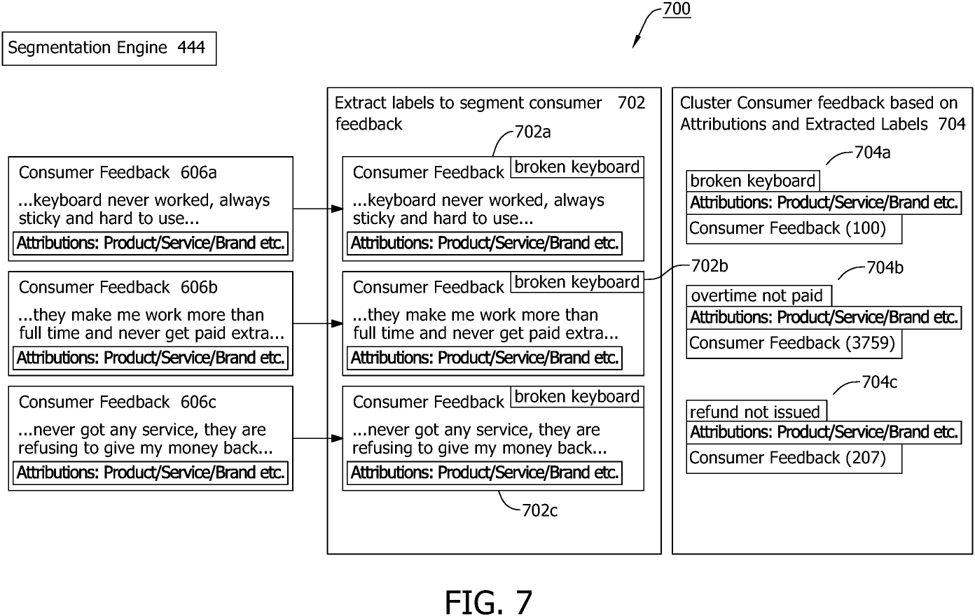

FIG. 7 depicts an example diagram 700 of how the Segmentation Engine module 444 of FIG. 4 may utilize algorithms to cluster consumer feedback based on nature of issue faced by consumers automatically or semi-automatically. Moving from left to right, this diagram is split into three sections, a Consumer Feedback section, an Extract Labels to Segment Consumer Feedback section, and a Cluster Consumer feedback based on Attributions and Extracted Labels section.

In the Consumer Feedback section, it is shown that the processed raw consumer feedback data 606a-606c, like “... keyboard never worked, always sticky and hard to use....,” may be assigned particular attributions, such as Product/Service/Brand etc. Next, the Extract Labels to Segment Consumer Feedback section 702 may take that data, which is now attributed, and further segment such data into categories which describe the nature of the issue concerning the attributed data, items 702a-702c. Lastly, in the Cluster Consumer feedback based on Attributions and Extracted Labels section 704, the attributed and labelled data can be clustered, items 704a-704c, with other processed consumer data for further analysis and/or manipulation in order to determine potential class action law suits and law firms which may litigate those potential class actions.

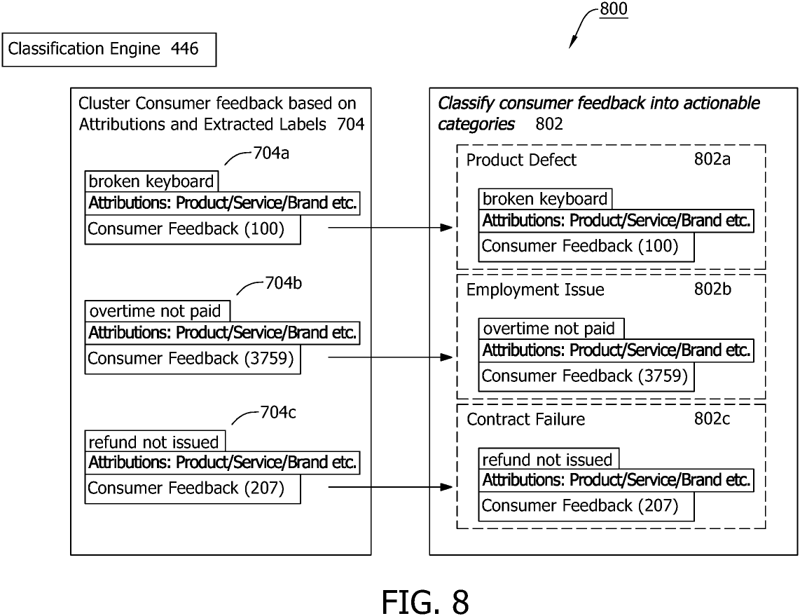

FIG. 8 depicts an example diagram 800 of how the Classification Engine module 446 of FIG. 4 may utilize algorithms to put groups of consumer harm into a class action category. The Cluster Consumer feedback based on Attributions and Extracted Labels section 704 shows that the consumer data, which has been attributed and labelled (704a-704c), may be passed over to the Classify consumer feedback into actionable categories section 802 to group the data into legal categories, such as Product Defect 802a, Employment Issue 802b, or Contract failure 802c, for example.

It is appreciated that the algorithms may be modified to suit the needs of the one or more users/clients based on preferences, or the like. Ranking scores and thresholds may be continually modified and changed until a satisfactory pattern output is achieved, but certain ranking scores and thresholds will likely change over time with consumer feedback evolution and new types of class action issues being introduced. The result of this is that the AI/ML configurations may be continually tweaked to ensure optimal results. For example, class action certification may be modified in the future to increase the number of participants required to be in a class, say from 100 to 200, as such, the algorithms disclosed herein would have to follow suit and only suggest a class action lawsuit when there are at least 200 aggregated reviews with similar complaints.

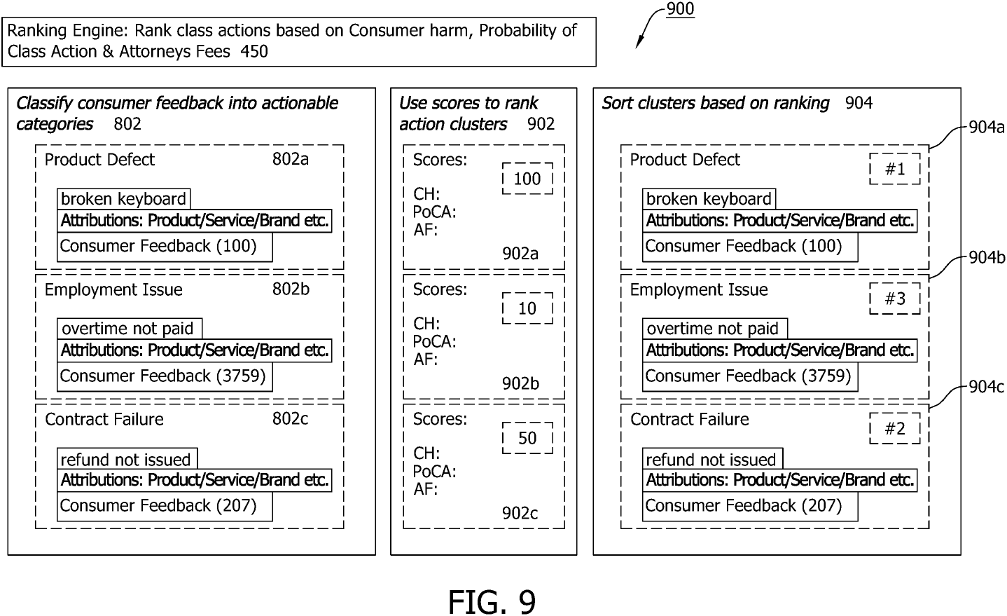

FIG. 9 illustrates an example diagram 900 of how Ranking Engine 450 may rank class actions based on consumer harm and the probability of a class action and its attorney’s fees. In the Classify consumer feedback into actionable categories section 802, the consumer data which has now been attributed/labelled/assigned a legal cause of action (802a-802c), may be ready to be assigned a score/ranking. Consumer feedback 802a-802c may be fed into Use scores to rank action clusters section 902. Section 902 may assign a score based off a formula, such as the Ranking Algorithm 510 of FIG. 5. In some embodiments, the score may be used to rank class action clusters to decide what groups of processed consumer data are the best targets for class action lawsuits. In the Sort clusters based on ranking section 904, it is shown that the processed consumer feedback data may be put in a form of sort order which may dictate when and how each group of consumer feedback data will be evaluated and decided upon for class action lawsuits. In the example, the sort order 904a, 904b, 904c, is provided. It is appreciated that the ranking and sorting may be modified to result in the most optimal output from the AI/ML engine disclosed.

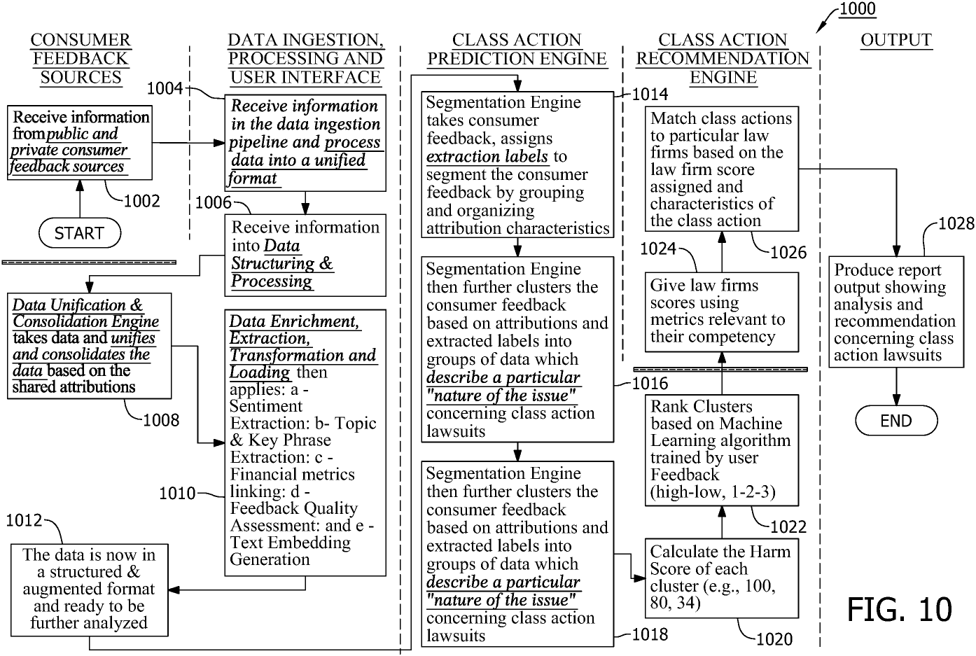

FIG. 10 depicts a flow diagram 1000 illustrating an example flow of a consumer harm risk assessment engine. The example flow diagram is split into five distinct sections: (1) Consumer feedback sources, (2) Data Ingestion Processing and User interface, (3) Class action prediction engine, (4) Class action recommendation engine, and (5) Output.

In the Consumer Feedback Sources section, starting at block 1002 the Data layer may receive information from public and private consumer feedback sources from the Source Data. This data may then be fed to a AI/MI, engine disclosed herein, and form the basis of the content which drives the class action lawsuit prediction.

In the Data Ingestion Processing and User Interface section, per block 1004, the data layer may forward the received information from the data layer into the Data Ingestion Pipeline to process such data into a unified format so that the data from disparate sources may be evaluated and analyzed by one system easily. For example, the data may come from multiple operating systems in different data formats, like data from a SQL database, NoSQL database, flat files, streaming text, streaming video, streaming audio, JSON or XML APIs, or even data coming from a custom propriety system, which is not widely used in a data format, being unorthodox.

In block 1006, the data processed up to this point may be received into Receive Information into Data Structuring & Processing system. Per block 1008, the Data Unification & Consolidation Engine may take data and unify it and consolidate it based on shared attributions like brand, product, and issue, for example. In block 1010 the Data Enrichment, Extraction, Transformation and Loading may then apply further processing to the data with the following components: a - Sentiment Extraction; b - Topic & Key Phrase Extraction; c - Financial metrics linking; d -Feedback Quality Assessment; and e - Text Embedding Generation.

Once the data is made into a unified format, the data is enriched by gathering information on it. For example, for a particular comment, the process may enrich it by its sentiment (negative or positive comment), the main topic of the comment, the sales volume of the product being discussed in the comment, the reliability of the comment (is it a bot?), and spotting patterns in the comments using text embedding, for example. In block 1012, the data may be in a structured and augmented format and considered ready to be subject to further analysis.

Moving onto the Class Action Prediction Engine section, per block 1014, the Segmentation Engine may extract labels from the consumer feedback data (e.g., feedback with the phrase “keyboard never worked” may generate the label “broken keyboard”) to normalize the feedback text to one or more labels. Per block 1016, the Segmentation engine may cluster the consumer feedback based on attributions and extracted labels into groups.

Continuing on with the Class Action Prediction Engine, per block 1018, the engine may classify the consumer feedback into actionable categories from a legal perspective. For example, actionable categories may include: 1 - Product Defect; 2 - Employment Issue; or 3 - Contract failure. Per block 1020, the process may calculate the harm score of the clusters based off a formula, such as a formula of the Ranking Algorithm system 510. Per block 1022, the process may rank clusters based on a machine learning algorithm trained by user feedback.

In the Class Action Recommendation Section, per block 1024, law firms may be scored using metrics relevant to the competency of a particular law firm to litigate a certain class action. Then, per block 1026, the class actions may be matched to a particular law firm based on one or more of the law firm scoring metrics.

In the Output section, per block 1028, a report output may be produced showing analysis and recommendation concerning class action lawsuits.

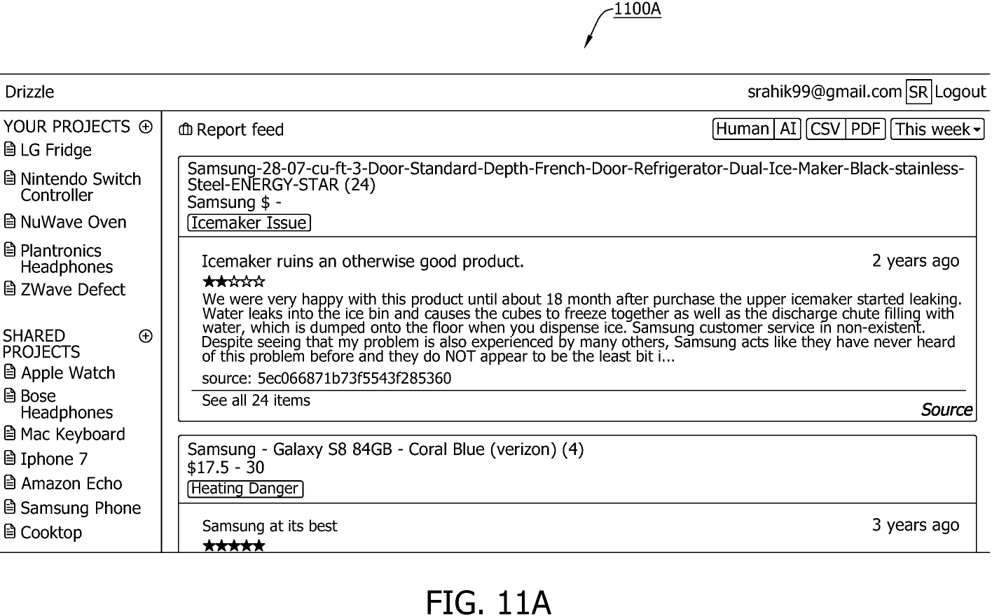

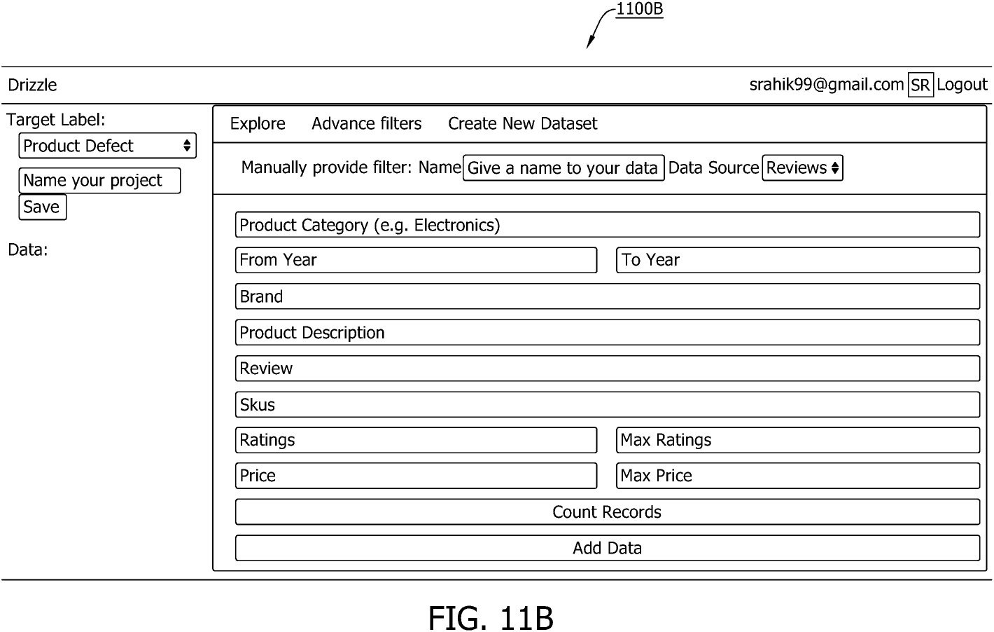

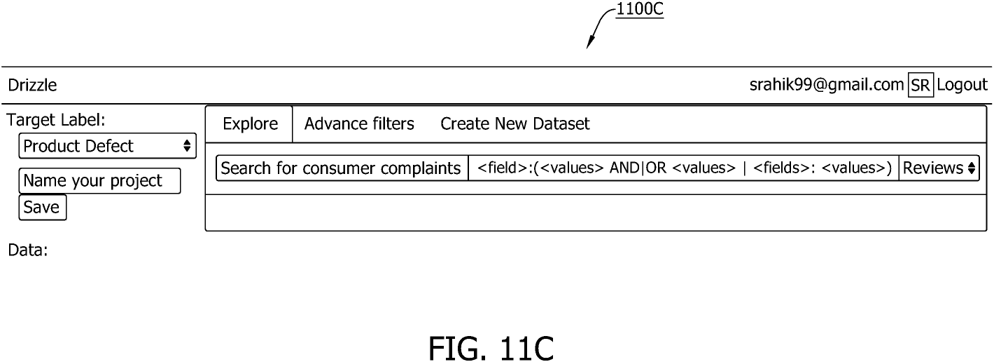

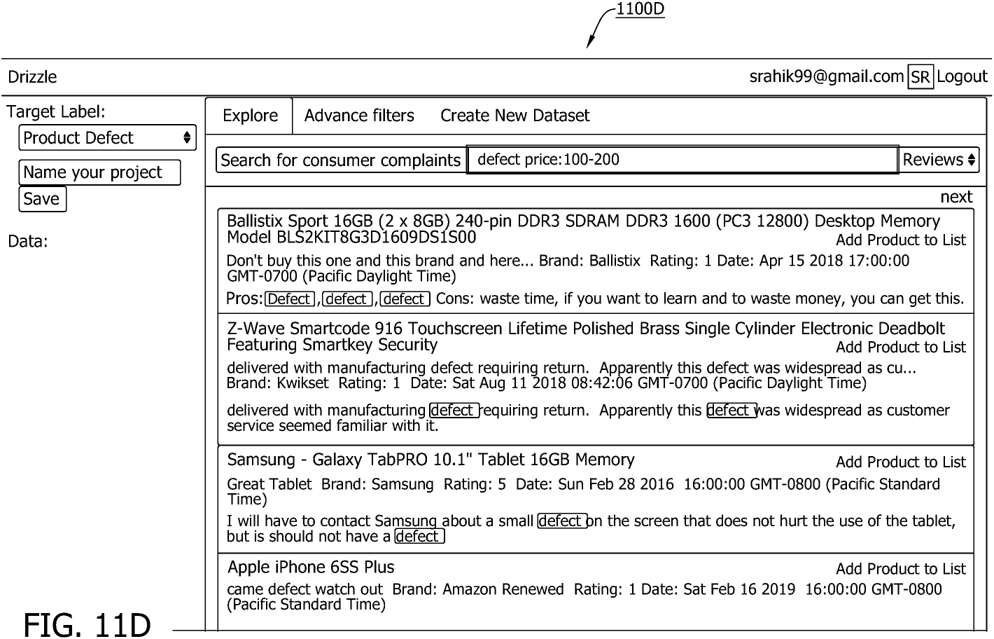

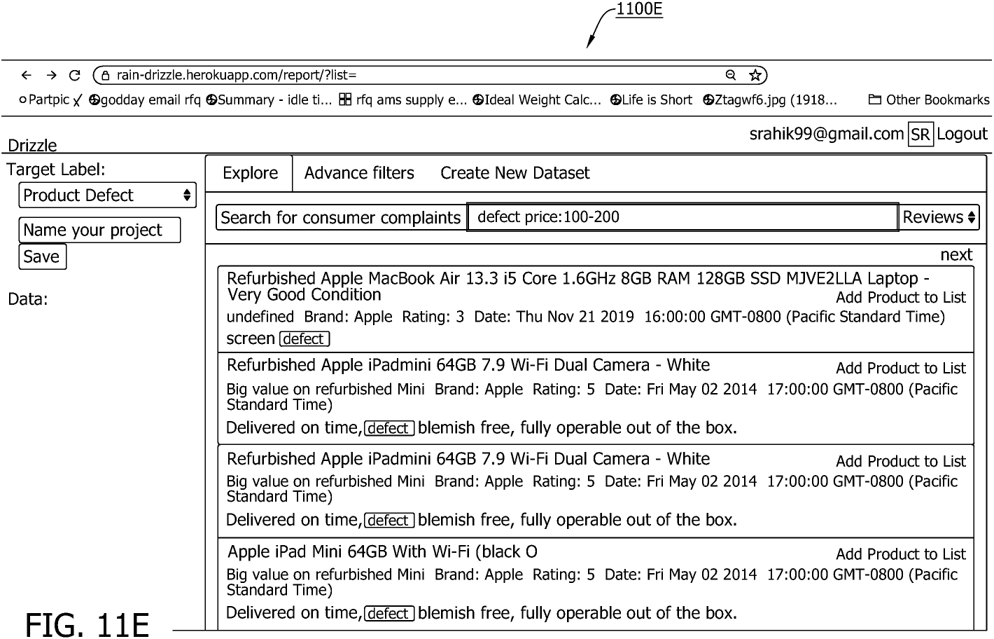

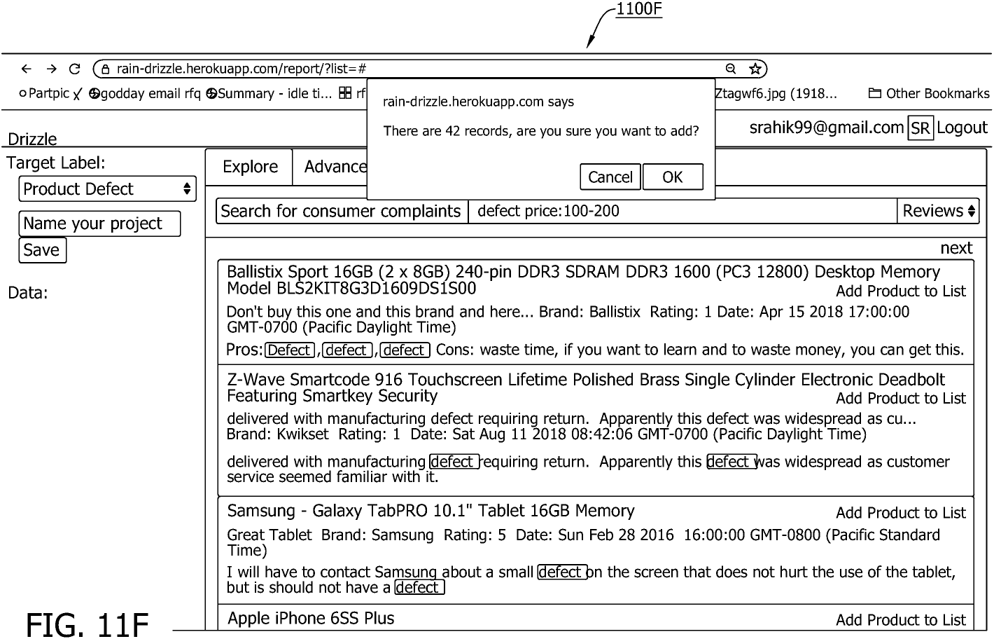

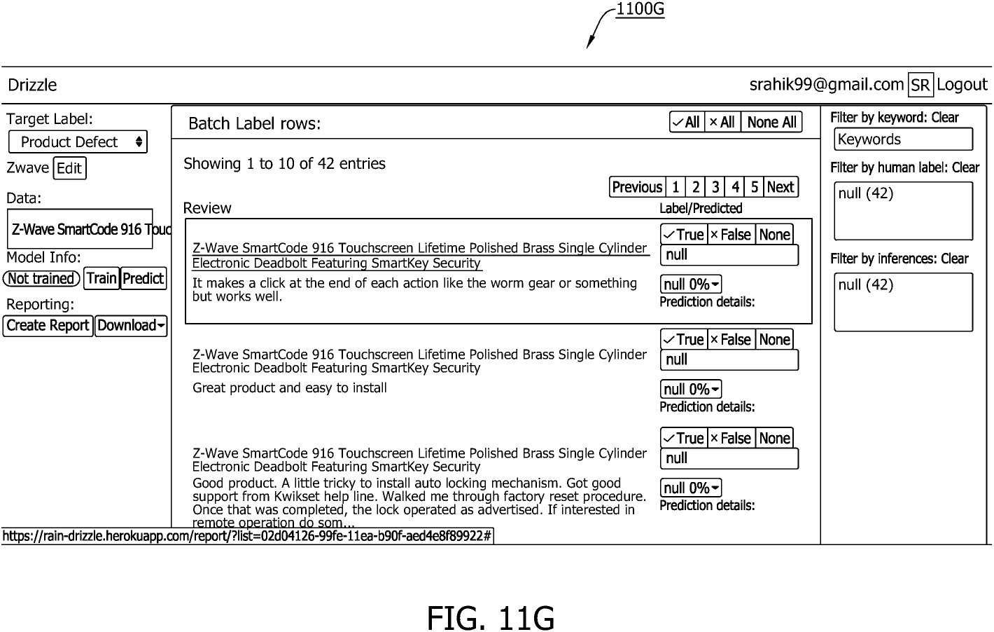

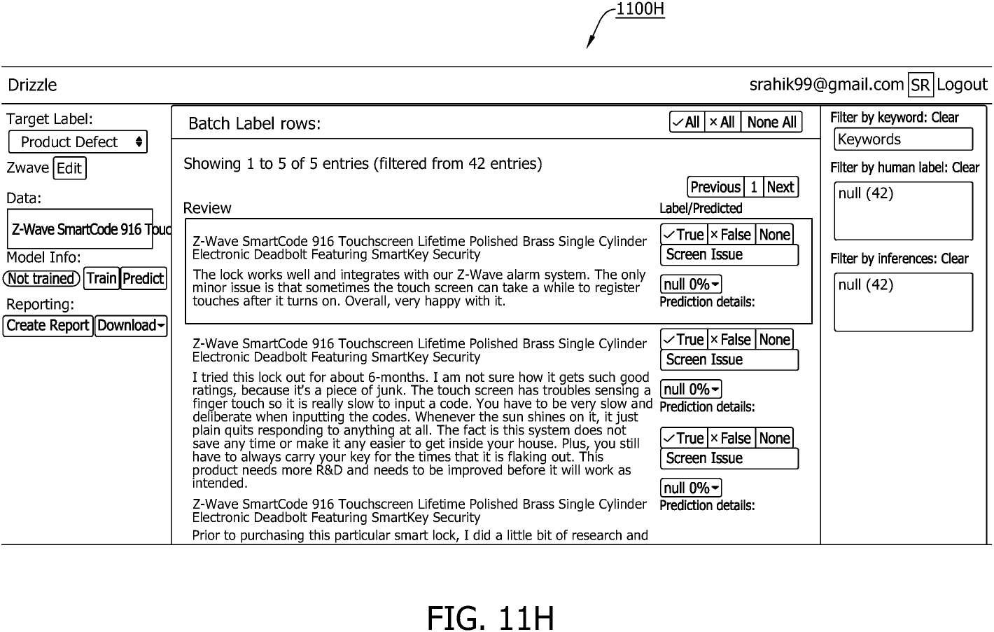

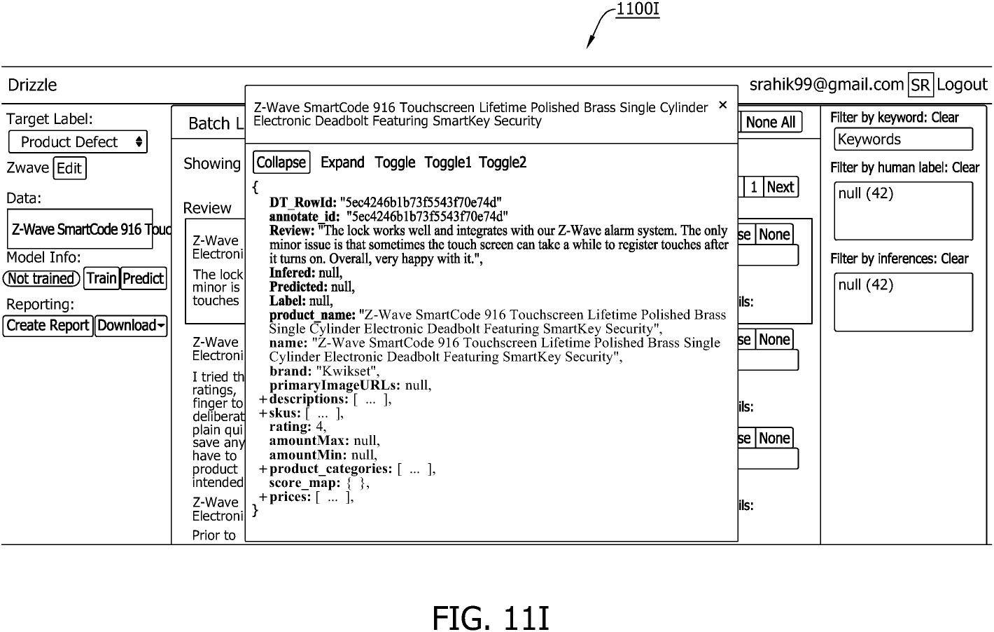

FIGS. 11A-11I provide screenshots 1100A-1100I of an exemplary user interface in accordance with embodiments of the disclosed. may allow a user work through the processes described herein.

### Artificial Intelligence, Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data to facilitate making predictions for subsequent data. Models may be created based upon example inputs to make valid and reliable predictions for novel inputs.

Additionally or alternatively, the machine learning programs may be trained by inputting sample data sets or certain data into the programs, such as images, object statistics and information, audio and/or video records, text, and/or actual true or false values. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing — either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

As described above, the systems and methods described herein may use machine learning, for example, for pattern recognition. That is, machine learning algorithms may be used by CAL computing device 102, for example, to identify patterns between initial and subsequent feedback provided by entities, such as clients or agencies, and in view of recommendations made by the CAL computing device 102. Accordingly, the systems and methods described herein may use machine learning algorithms for both pattern recognition and predictive modeling.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method implemented by a class action lawsuit (CAL) computing device including at least one processor in communication with at least one memory device, the computer-implemented method comprising:
retrieving, from the at least one memory device, historical consumer feedback data;
generating a model that identifies potential class actions or other types of aggregate litigation by classifying the historical consumer feedback data;
storing the model in the at least one memory device;
receiving consumer feedback data from one or more data sources; and
providing at least one class action lawsuit recommendation based upon the generated model and the consumer feedback data.

2. The computer-implemented method of claim 1, wherein the one or more data sources include public data sources, private data sources, or both.

3. The computer-implemented method of claim 2, wherein the public data sources and private data sources include one or more of ecommerce platforms, product and service forums platforms, news and blogs platforms, social media platforms, audio and video publishing platforms, and government entities.

4. The computer-implemented method of claim 1, wherein providing at least one class action lawsuit recommendation comprises:
processing the consumer feedback data into a unified format;
clustering the consumer feedback data into one or more clusters based on one or more shared attributions or one or more labels;
classifying the consumer feedback in each cluster into one or more actionable categories;
determining a likelihood of potential consumer harm of the consumer feedback data in each of the one or more clusters; and
providing a report or recommendation that includes at least one potential class action based at least in part on the determined likelihood and the one or more actionable categories.

5. The computer-implemented method of claim 4, wherein the computer-implemented method further comprises:
updating the model based upon the at least one class action lawsuit recommendation and the received consumer feedback data.

6. The computer-implemented method of claim 1, wherein the model is built using data analysis, machine learning, artificial intelligence, or a combination thereof.

7. A computer-implemented method implemented by a class action lawsuit (CAL) computing device including at least one processor in communication with at least one memory device, the computer-implemented method comprising:
retrieving, from the at least one memory device, historical consumer feedback data;
generating a model that identifies potential class actions or other types of aggregate litigation by classifying the historical consumer feedback data;
receiving consumer feedback data from one or more data sources; and
providing a class action lawsuit recommendation based upon the generated model and the consumer feedback data in addition to one or more law firms determined to match the class action lawsuit recommendation.

8. The computer-implemented method of claim 7, wherein the one or more data sources include public data sources, private data sources, or both.

9. The computer-implemented method of claim 8, wherein the public data sources and private data sources include one or more of ecommerce platforms, product and service forums platforms, news and blogs platforms, social media platforms, audio and video publishing platforms, and government entities.

10. The computer-implemented method of claim 7, wherein providing at least one class action lawsuit recommendation comprises:
processing the consumer feedback data into a unified format;
clustering the current consumer feedback data into one or more clusters based on one or more shared attributions or one or more labels;
classifying consumer feedback data in each cluster into one or more actionable categories;
determining likelihood of potential consumer harm of the consumer feedback data in each of the one or more clusters; and
providing a report or recommendation that includes at least one potential class action lawsuit based at least in part on the determined likelihood and the one or more actionable categories.

11. The computer-implemented method of claim 12, wherein the computer-implemented method further comprises:
updating the model based upon the at least one class action lawsuit recommendation and the received consumer feedback data.

12. The computer-implemented method of claim 8, wherein the model is built using data analysis, machine learning, artificial intelligence, or a combination thereof.

13. At least one non-transitory computer readable medium having instructions embodied thereon, wherein when executed by a class action lawsuit (CAL) computing device including at least one processor in communication with at least one memory device, the instructions cause the at least one processor to:
retrieve, from the at least one memory device, historical consumer feedback datas;
generate a model that identifies potential class actions or other types of aggregate litigation by classifying the historical consumer feedback data;
store the model in the at least one memory device;
receive consumer feedback data from one or more data sources; and
provide at least one class action lawsuit recommendation based upon the generated model and the consumer feedback data.

14. The at least one non-transitory computer readable medium of claim 13, wherein the one or more data sources include one or more public data sources.

15. The at least one non-transitory computer readable medium of claim 13, wherein the one or more data sources include one or more private data sources.

16. The at least one non-transitory computer readable medium of claim 13, wherein the one or more data sources include public data sources and private data sources.

17. The at least one non-transitory computer readable medium of claim 16, wherein the public data sources and private data sources include one or more of ecommerce platforms, product and service forums platforms, news and blogs platforms, social media platforms, audio and video publishing platforms, and government entities.

18. The at least one non-transitory computer readable medium of claim 15, wherein providing at least one class action lawsuit recommendation comprises:
processing the consumer feedback data into a unified format;
clustering the consumer feedback data into one or more clusters based on one or more shared attributions or one or more labels;
classifying consumer feedback data in each cluster into one or more actionable categories;
determine a likelihood of potential consumer harm of the consumer feedback data in each of the one or more clusters; and
providing a report or recommendation that includes at least one potential class action based upon the likelihood and the one or more actionable categories.

19. The at least one non-transitory computer readable medium of claim 18, wherein the matching further comprises:
updating the model based upon the at least one class action lawsuit recommendation and the received consumer feedback data.

20. The at least one non-transitory computer readable medium of claim 19, wherein the model is built using data analysis, machine learning, artificial intelligence, or a combination thereof.
